(19) United States
(12) Patent Application Publication
(10) Pub. No.: US 2026/0087569 A1
(43) Pub. Date: Mar. 26, 2026

(54) CONTROL DEVICE FOR CONTROLLING DISPLAY DEVICE PROVIDED AT SEAT

(71) Applicant: FOOD & LIFE COMPANIES LTD., Osaka (JP)

(72) Inventor: Hiroshi OGAWA, Suita Osaka (JP)

(21) Appl. No.: 19/335,025

(22) Filed: Sep. 22, 2025

Related U.S. Application Data
(63) Continuation of application No. PCT/JP2024/025967, filed on Jul. 19, 2024.

(51) Int. Cl. G06Q 50/12

(52) U.S. Cl. CPC G06Q 50/12

(57) ABSTRACT

A control device controls a display device provided at a seat, including a processor and memory storing instructions that cause the control device to display an order screen on the display device, which is used by a customer seated in the seat to order items. The order screen includes a moving display area that sequentially displays each of multiple images, including images of items available for ordering, moving in a predetermined direction along a lane. The instructions further cause the control device to accept settings of items subject to discount and the remaining quantity of such discounted items, and display images announcing the discounted items and images indicating the remaining quantity of discounted items as part of the multiple images in the moving display area of the order screen, when settings for the item subject to discount and the remaining quantity of the discounted item are received.

### CROSS-REFERENCE TO RELATED APPLICATION

This application is a continuation of International Patent Application No. PCT/JP2024/025967 filed Jul. 19, 2024, the entire contents of which are incorporated herein by reference.

### BACKGROUND OF THE INVENTION

### Technological Field

The present invention relates to a control device. More specifically, the present invention relates to a control device for controlling a display device provided at a seat.

### Background Art

Various systems for accepting customer orders have been conventionally proposed for establishments providing food and beverages. For example, Patent Document 1 below discloses a technology that detects a customer's selection action on image data of food and beverages being scroll-displayed on a display unit, and displays data related to the selected food and beverage on the display unit through masking processing.

### PRIOR ART DOCUMENTS

### Patent Documents

[Patent Document 1] Japanese Patent No. 5715942

### SUMMARY OF THE INVENTION

### Problem to be Solved by the Invention

However, there is still a demand for providing technology with higher convenience for customers. Such demand is not limited to establishments providing food and beverages as mentioned above, but is common to establishments providing any type of merchandise. The present invention has been made in view of the above circumstances and provides technology that enables improvement of convenience for customers.

### Means for Solving the Problems

According to one aspect of the present invention, a control device for controlling a display device provided at a seat comprises: a display unit that displays an order screen on the display device, the order screen being used by a customer seated at the seat to order items, wherein the order screen includes a moving display area that sequentially displays each of multiple images, including images of items available for ordering, moving along a lane in a predetermined direction; and a designation receiving unit that receives settings for discounted items among the items available for ordering and the remaining quantity of the discounted items, wherein when the designation receiving unit receives settings for the discounted item and the remaining quantity of the discounted item, the display unit displays an image announcing the discounted item and an image indicating the remaining quantity of the discounted item as part of the multiple images in the moving display area of the order screen.

Preferably, in the above mentioned control device, it further comprises an order receiving unit for receiving an order for a discounted item through the display device, and when the order receiving unit receives an order for the discounted item, the display unit reduces the remaining quantity of the discounted item displayed in the moving display area of the order screen based on the order for the discounted item.

In the above-mentioned control device, preferably, the display unit causes an image indicating the remaining quantity of discounted item to be included within the image announcing the discounted items.

In the above-described control device, preferably, the display unit sequentially displays an image announcing the item subject to discount and images of the item subject to discount in a quantity equal to the remaining number of the items subject to discount.

According to another aspect of the present invention, a control device for controlling a display device provided at a seat comprises: an order screen display unit that displays a first order screen on the display device, the first order screen being used by a customer seated at the seat to order items; a data storage unit that stores data of a second order screen used by the customer to order items; a generation unit that generates storage location information including information about the storage location of the second order screen data; and a transmission unit that, when receiving access to the storage location of the second order screen data from a customer terminal device possessed by the customer based on the storage location information, transmits the second order screen data to the customer terminal device, wherein each of the first and second order screens includes a moving display area that sequentially displays each of a plurality of images, including images of items to be ordered, moving along a lane in a predetermined direction, and wherein the movement of each of the plurality of images in the first order screen is synchronized with the movement of each of the plurality of images in the second order screen.

Preferably, in the above-described control device, the device further comprises a visit information acquisition unit for acquiring visit information, which is information assigned to a customer at the time of their visit, and the generation unit generates, as data storage location information, a code including a storage location of the second order screen data, the visit information, and seat information that identifies a seat.

In the above-mentioned control device, preferably, the device further comprises: a first order receiving unit for receiving order information made through the display device from the display device; a second order receiving unit for receiving order information made through the customer terminal device along with visit identification information and seat information from the customer terminal device; and an order management unit for managing the order information received by the first order receiving unit and the order information received by the second order receiving unit as orders made at the same seat.

### Effects of the Invention

According to the present invention, it is possible to improve convenience for customers.

### BRIEF DESCRIPTION OF DRAWINGS

FIG. 1 is a schematic block diagram showing a system configuration of a management system 100 according to the present invention.

FIG. 2 is a diagram showing a specific example of an external appearance of an establishment system 110.

FIG. 3 is a diagram showing a specific example of an order screen.

FIG. 4 is a diagram showing a specific example of display changes when customers perform item ordering operations.

FIG. 5 is a diagram showing a specific example of display changes when customers perform item ordering operations.

FIG. 6 is a diagram showing a specific example of a support setting screen.

FIG. 7 is a diagram for explaining an item display function.

FIG. 8 is a diagram showing an example where a campaign information image 443 is displayed.

FIG. 9 is a diagram showing an example of a screen when campaign information is operated.

FIG. 10 is a diagram showing an example of a screen when campaign information is operated.

FIG. 11 is a diagram showing a specific example of a menu screen 436.

FIG. 12 is a diagram showing a first example in which an image indicating discount information is displayed in a moving display area 440 of an order screen displayed on the establishment display device 43.

FIG. 13 is a diagram showing a second example in which an image indicating discount information is displayed in a moving display area 440 of an order screen displayed on the establishment display device 43.

FIG. 14 is a diagram showing an image 447 indicating the remaining quantity of discounted items after the order of the discounted items has been executed in the first example.

FIG. 15 is a diagram showing an image 447 indicating the remaining quantity of discounted items after the order of the discounted items has been executed in the second example.

FIG. 16 is a diagram showing an example of displaying an order screen on the customer terminal device 10 synchronized with the order screen displayed on the establishment display device 43.

FIG. 17 is a diagram showing an example of operations performed when displaying a customer terminal screen on the customer terminal device 10.

FIG. 18 is a schematic block diagram showing a specific example of the management device 20.

FIG. 19 is a diagram showing a specific example of a customer information table.

FIG. 20 is a schematic block diagram showing a specific example of an establishment control device 30.

FIG. 21 is a flowchart showing a specific example of processing performed by the establishment control device 30.

FIG. 22 is a diagram showing a schematic overview of an example hardware configuration of an information processing device 90 applicable to the present embodiment.

FIG. 23 is a diagram showing a modified example of an image displaying discount information that is shown in a moving display area 440 of an order screen displayed on an establishment display device 43.

### DETAILED DESCRIPTION OF THE INVENTION

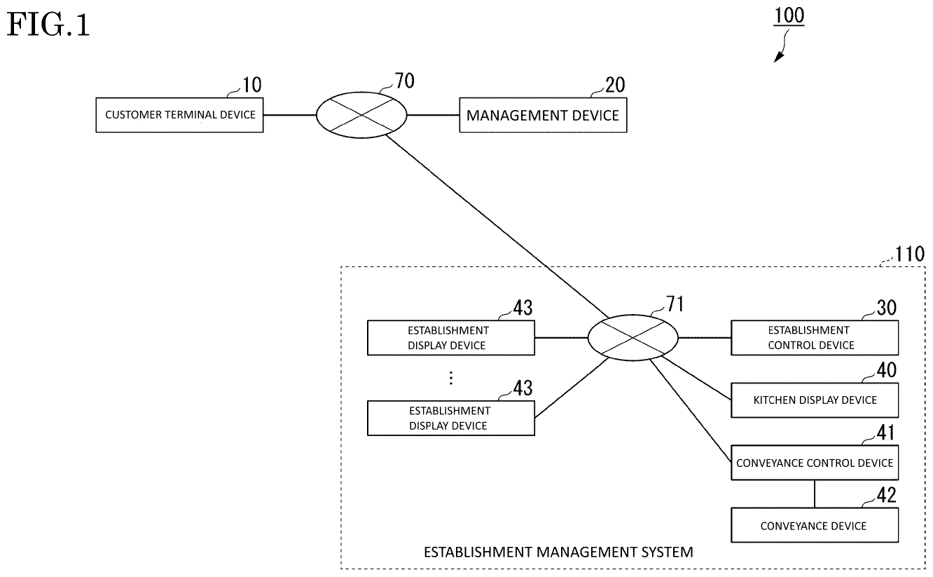

FIG. 1 is a schematic block diagram showing the system configuration of the management system 100 according to the present invention. The management system 100 includes a customer terminal device 10, a management device 20, and an establishment system 110. The customer terminal device 10, the management device 20, and the establishment system 110 are communicably connected via a network 70. The network 70 may be a network using wireless communication or a network using wired communication. The network 70 may be configured using the Internet, or may be configured using a Local Area Network (LAN). The network 70 may be configured by combining multiple networks.

The customer terminal device 10 is a terminal device used by a customer who orders and receives items at establishments managed by the management system 100. The managed establishments may be, for example, establishments that provide food and beverages to customers. In this case, the items are food and beverages. However, the items provided to customers at the managed establishments are not limited to food and beverages. The customer terminal device 10 is an information processing device such as a smartphone, mobile phone, personal computer, tablet terminal, portable game console, wearable computer, etc. The customer terminal device 10 is capable of communicating with other devices via network 70.

The management device 20 is a device that manages the establishment system 110 installed in establishments that are management targets of the management system 100. The management device 20 is configured using an information processing device such as a personal computer, tablet terminal, or server device. The management device 20 accepts registration of data related to a group of items (hereinafter referred to as “item group data”) that can be provided as menu items in establishments that are management targets of the management system 100. The item group data includes, for example, images of multiple items that can be provided as menu items, and information related to each item (for example, price, information about ingredients, information about preparation, etc.).

Registration of item group data is performed by a person having predetermined authority such as an administrator of the management device 20. The registration of item group data may be performed in any manner. The registration of item group data may be performed by the administrator operating an input/output device (user interface) provided in the management device 20. The registration of item group data may be performed by the administrator transmitting the item group data to the management device 20 from another information processing device.

The establishment system 110 is provided in one or more establishments that are management targets of the management system 100. The establishment system 110 is provided for each establishment where food and beverages are served. In this case, each item included in the item group data is a food or beverage item. The establishment system 110 includes an establishment control device 30 (an example of a control device), a kitchen display device 40, a conveyance control device 41, a conveyance device 42, and multiple establishment display devices 43 (examples of display devices). Each device in the establishment system 110 is communicably connected via a network 71 provided in the establishment system 110. The network 71 may be configured using, for example, LAN or wireless LAN.

The establishment control device 30 is a device that controls each apparatus provided in the establishment system 110. The establishment control device 30 is configured using an information processing device such as a personal computer or server device. The establishment control device 30, for example, receives item group data transmitted from the management device 20, determines items to be displayed (hereinafter referred to as “display target items”) on the establishment display device 43 in the establishment system 110, and causes the images of the display target items to be displayed on the establishment display device 43. The establishment control device 30 may also determine items selected on the kitchen display device 40 as display target items.

The kitchen display device 40 is a device used by kitchen managers in the establishment system 110. The kitchen display device 40 is an information processing device such as a smartphone, mobile phone, personal computer, tablet terminal, portable game console, wearable computer, or dedicated terminal. The kitchen display device 40 displays items included in the item group data transmitted from the management device 20 as item candidates. The kitchen display device 40 notifies the establishment control device 30 of items selected by the kitchen manager. Additionally, the kitchen display device 40 displays information regarding orders placed by customers through operations on the establishment display device 43 or customer terminal device 10 (hereinafter referred to as “order information”). The order information may include information indicating the seat where the ordering customer is located, information indicating the ordered items, and information indicating the quantity of ordered items. The kitchen manager prepares and provides items (food and beverages) to customers according to the order information displayed on the kitchen display device 40.

The conveyance control device 41 controls the operation of the conveyance device 42. The conveyance control device 41 may control the operation of the conveyance device 42 according to control signals transmitted from, for example, the establishment control device 30 or the kitchen display device 40. The conveyance device 42 transports items prepared by the kitchen manager to customers. The conveyance device 42 is configured using, for example, a conveyor.

The establishment display device 43 may be an image display device such as a liquid crystal display or an organic EL (Electro Luminescence) display. The establishment display device 43 may be configured as a touch panel further equipped with an input device.

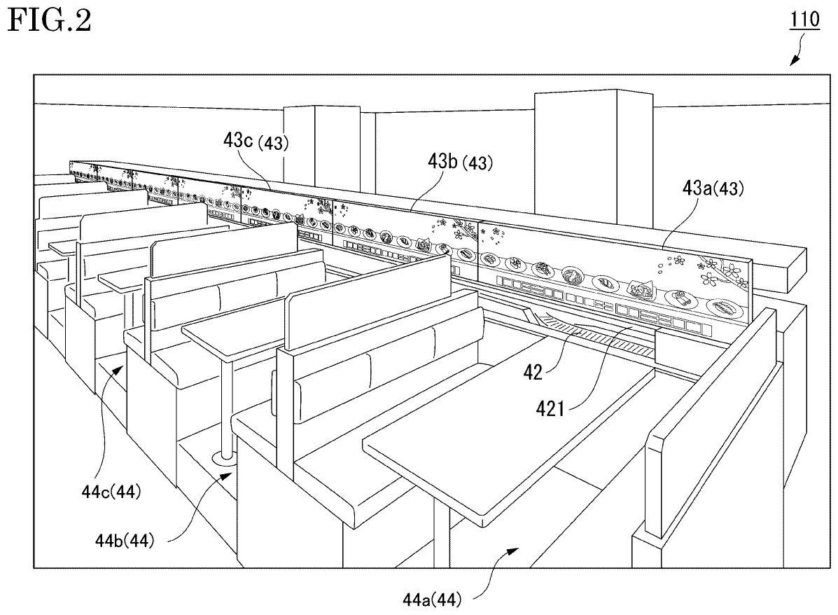

FIG. 2 is a diagram showing a specific example of the external appearance of the establishment system 110. Multiple unit seats 44 are provided in the establishment. A unit seat 44 is a seat used by a group of one or more customers for whom payment is processed together. The unit seat 44 may be configured as a seat used by a single customer (for example, a single-person seat provided at a counter), or as shown in FIG. 2, it may be configured as a seat used by multiple persons. One or more establishment display devices 43 may be provided for each unit seat 44.

In the example of FIG. 2, one establishment display device 43 is provided for one unit seat 44. For example, establishment display device 43a is provided for unit seat 44a, and establishment display device 43b is provided for unit seat 44b, and establishment display device 43c is provided for unit seat 44c.

The conveyance device 42 is provided to be capable of transporting items from at least the kitchen to each unit seat 44. Each unit seat 44 is provided with at least one receiving port 421. The conveyance device 42 is configured to, for example, transport items from the kitchen to the receiving port 421 and stop the items at the receiving port 421.

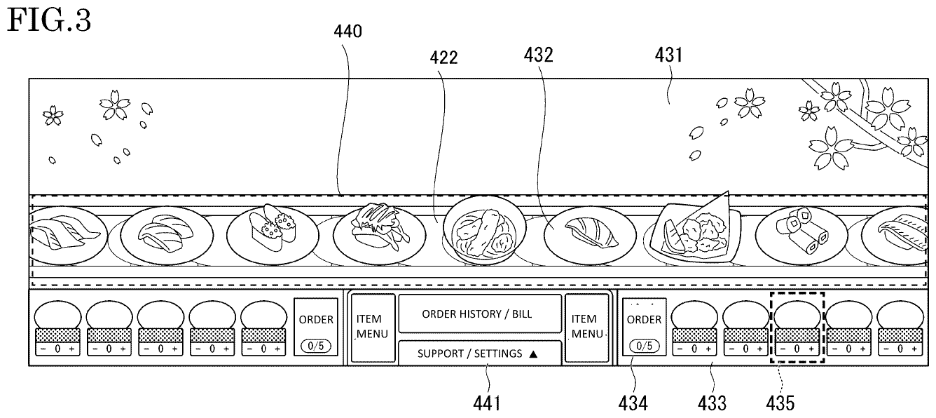

An order screen used by customers seated in each unit seat 44 to order items is displayed on the establishment display device 43 provided at each unit seat 44. FIG. 3 is a diagram showing a specific example of the order screen. In the specific example of FIG. 3, at least an image 422 of the conveyance device 42 and one or more item images 432 are displayed in a moving display area 440 (area shown by dotted lines in FIG. 3, which serves as an example of a moving display area). Additionally, as shown in FIG. 3, an information display area 431, an order operation area 433, and a setting operation area 441 may also be displayed. The item images 432 here are images of items such as sushi served on plates.

In the moving display area 440, the image 422 of the conveyance device 42 may be displayed to form a lane and move at a predetermined speed in a predetermined direction. The item images 432 may be sequentially displayed to move along the lane at a predetermined speed in a predetermined direction. For example, the image 422 of the conveyance device 42 and each item image 432 may be displayed to move from right to left at a predetermined speed. By displaying the image 422 of the conveyance device 42 and the item images 432 moving at the same speed in the same direction, it appears as if the items represented by each item image 432 are loaded on and moving with the conveyance device 42. More specifically, such display enables customers to view items (for example, sushi) moving along the lane, similar to what one would see in a conveyor belt sushi restaurant. The item images 432 may also be displayed to move without the movement of the image 422 of the conveyance device 42.

The establishment control device 30 or the establishment display device 43 may change the speed and direction of movement of these images in response to customer operations. Customer operations may be accepted as operations on the establishment display device 43 configured using a touch panel. For example, in response to a customer performing a flick operation having a component in a direction opposite to a predetermined direction on the touch panel, the image 422 of the conveying device 42 and the item image 432 may be temporarily displayed to move in a direction opposite to the predetermined direction. Additionally, in response to a customer performing a touch operation on the image 422 of the conveying device 42 or the item image 432, the movement of the image 422 of the conveying device 42 and the item image 432 may be temporarily stopped.

The information display area 431 is an area where information to be provided to customers is displayed. The control of what information is displayed in the information display area 431 may be performed by either the management device 20 or the establishment control device 30. For example, information to be provided may be transmitted from the management device 20 to the establishment control device 30 via network 70, and the information selected by the establishment control device 30 may be displayed in the information display area 431. For instance, the displayed information may include advertisements provided to customers, coupon information, or game screens that customers can interact with. The advertisement information provided to customers may be related to the operating entity of the establishment where the establishment system 110 is installed, or it may be related to other entities. In cases where the advertisement is related to other entities, advertising fees may be paid from the advertiser to the establishment's operating entity.

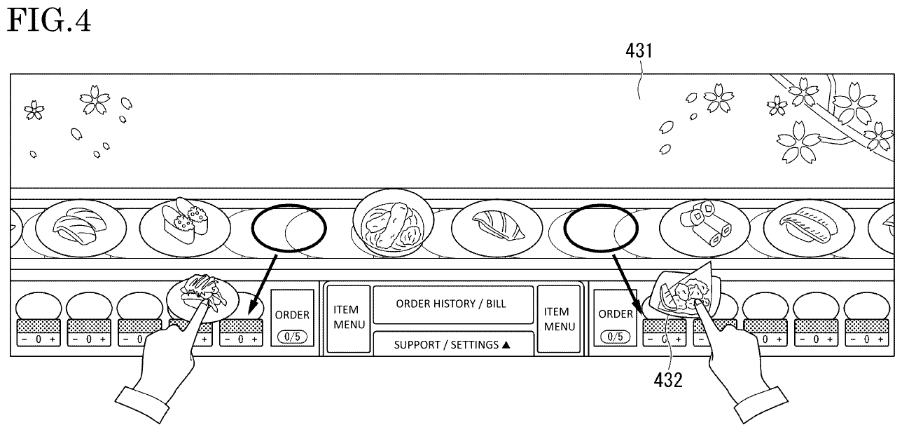

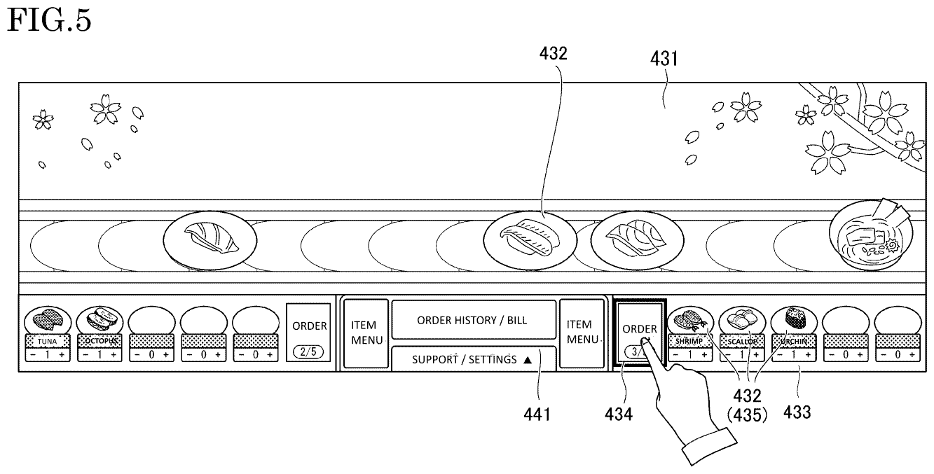

The order operation area 433 is an area used by customers to perform item ordering operations. FIGS. 4 and 5 show specific examples of display changes when customers perform item ordering operations. The order operation area 433 displays an order button 434 and multiple order candidate areas 435. The order button 434 is a button labeled “Order”. The order candidate area 435 is an area that shows items selected by customers as candidates for ordering. As shown in FIG. 3, when a customer has not selected any order candidates, none of the order candidate areas 435 display item images, and instead, an image indicating that no selection has been made is displayed.

When an item image 432 that is to be ordered (desired to be ordered) is displayed on the display screen, the customer performs a selection operation on the item image 432 that is to be ordered. For example, the selection operation may be a drag operation, a tap operation, or another type of operation. In the case of a drag operation, the customer drags the item image 432 to be ordered to the order operation area 433. In the case of a tap operation, the customer taps the item image 432 to be ordered. When the customer performs a selection operation on the item image 432, as shown in FIG. 5, the selected item image 432 is displayed in the order candidate area 435. As described above, the item image 432 displayed in the order candidate area 435 indicates that it has been selected by the customer as a candidate for ordering.

When a customer operates the order button 434, an order is executed for the items shown by the item images 432 displayed in the order candidate area 435 at the time of the operation. When an item order is executed, the establishment control device 30 registers information indicating the identification information of the unit seat 44 where the order was placed and identification information indicating the ordered items. The establishment control device 30 displays this information on the kitchen display device 40. Based on the information displayed on the kitchen display device 40, the kitchen manager (for example, the person preparing the food) prepares the items, places them on the conveyance device 42, and has them transported to the destination (the unit seat 44 where the ordering customer is located). The transported items (ordered items) are conveyed by the conveyance device 42 to the receiving port 421 of the unit seat 44 where the ordering customer is located. The customer who placed the order can retrieve the items that have been transported to the receiving port 421.

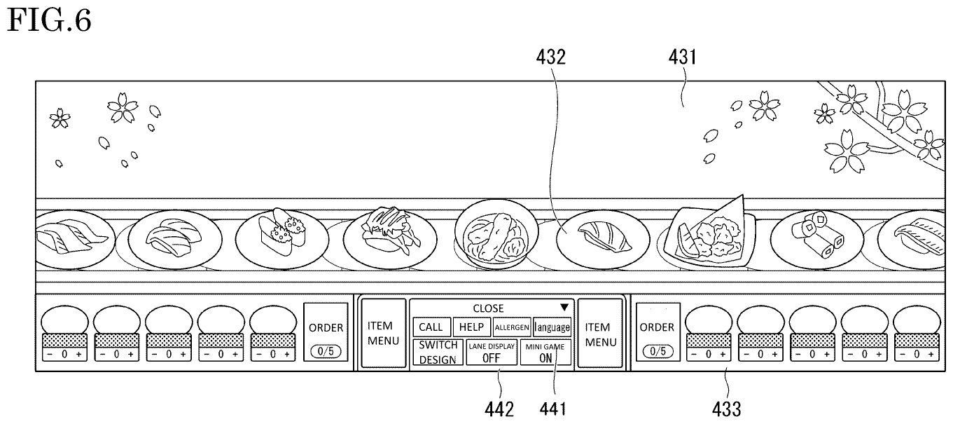

The setting operation area 441 displays a Support Settings button, an Item Menu button, and an Order History/Payment (Bill) button. When the Support Settings button is operated, a support settings screen is displayed. FIG. 6 is a diagram showing a specific example of the support settings screen. In FIG. 6, the support settings screen 442 is displayed by replacing part or all of the area where the setting operation area 441 was previously displayed. The support settings screen displays a call button, an operation explanation tutorial (help) button, an allergen information button, a language selection button, a design switch button, an ON/OFF button for displaying information about items on the lane, and an ON/OFF button for mini-games.

When the call button is operated, an output indicating that the call button has been operated at the unit seat 44 where the call button was operated is performed through an output device provided in the establishment system 110. For example, a lamp provided for each unit seat 44 may be illuminated, or seat identification information of the unit seat 44 may be displayed or output by voice.

When the operation instruction tutorial (help) button is operated, an operation instruction screen is displayed. On the operation instruction screen, videos or still images explaining the operation content may be displayed. When the allergen information button is operated, information regarding allergens in items provided at that establishment is displayed. For example, a table showing the relationship between the provided items and allergen-causing substances may be displayed.

When the language selection button is operated, multiple language buttons for other languages are displayed. For example, language buttons for English, French, German, Spanish, Chinese, and Korean may be displayed. When a language button is operated, the display on the establishment display device 43 is performed in the language assigned to the operated language button. When the design switching button is operated, the display design of the establishment display device 43 is switched to another design. Note that the effects of operating the language selection button and the design switching button are limited to the establishment display device 43 on which the operation was performed.

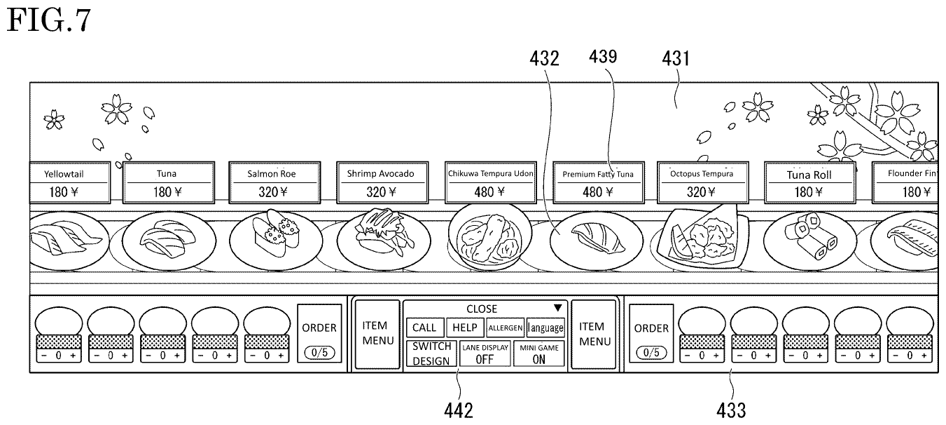

When the item information display ON/OFF button for the lane is operated, the item information display function switches between on and off states. In the state shown in FIG. 6, the item information display function is turned off. Therefore, item information (such as item name and price) is not displayed for each item image 432 flowing in the lane on the screen. FIG. 7 is a diagram for explaining the item display function. In FIG. 7, the item information display function is turned on. In this case, item information 439 is displayed for each item image 432 flowing in the lane on the screen. In the specific example of FIG. 7, the item name and item price are displayed as item information 439. The display area for item information 439 is arranged for each item image 432 flowing in the lane and moves in synchronization with the movement of the item image 432. As a result, it appears as if the item image 432 and the tag image showing the item information 439 are flowing together along the lane.

When the mini-game ON/OFF button is operated, a mini-game can be played using part or all of the screen of the establishment display device 43. For example, in response to the operation of the mini-game ON/OFF button, the mini-game application is launched and the mini-game screen is displayed. Subsequently, customers can play the mini-game by operating the control buttons displayed on the establishment display device 43. Coupons may be issued based on the performance in the mini-game.

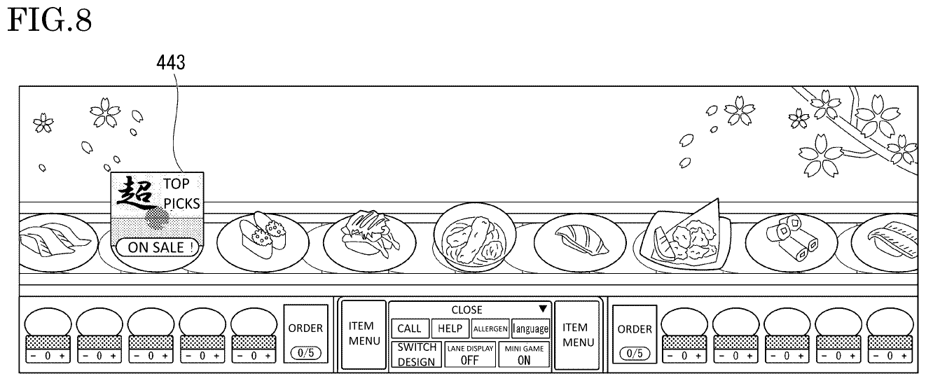

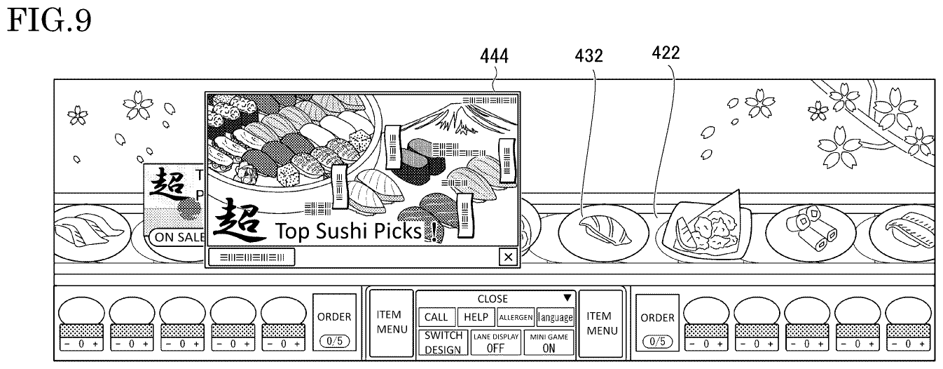

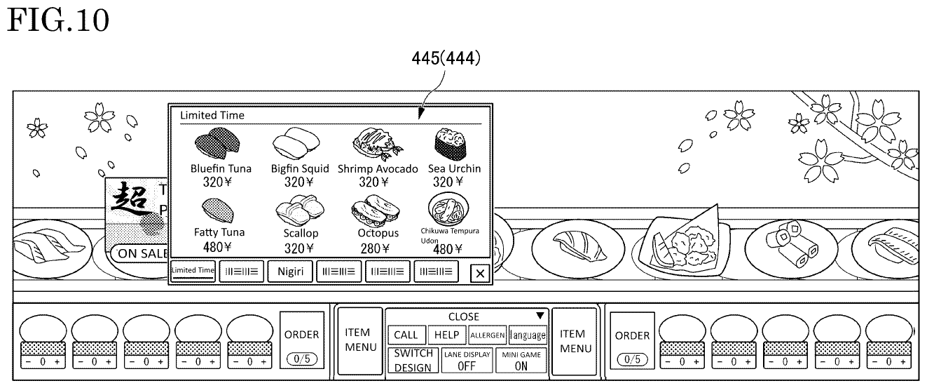

FIG. 8 is a diagram showing an example where a campaign information image 443 is displayed. Instead of the item image itself, an image 443 indicating a campaign being conducted at the establishment may be displayed on the lane of the establishment display device 43. FIGS. 9 and 10 are diagrams showing example screens when campaign information is operated. When the image indicating a campaign is operated, a campaign display area 444 showing the content of the campaign is displayed. The campaign display area 444 is displayed in a layer above the conveyor device image 422 and other item images 432. Therefore, while the campaign display area 444 is displayed statically, the lanes and item images 432 in the background may continue to flow.

When a menu button is operated in the campaign display area 444, text or images (campaign menu images) 445 indicating the menu are displayed in the campaign display area 444. FIG. 10 shows a specific example where the campaign menu image 445 is displayed. The campaign menu image 445 displayed in the campaign display area 444 shows images, names, and prices of items available in that campaign. When a specific item is selected in the campaign menu image 445, the selected item is displayed in the order candidate area 435 and becomes available for ordering.

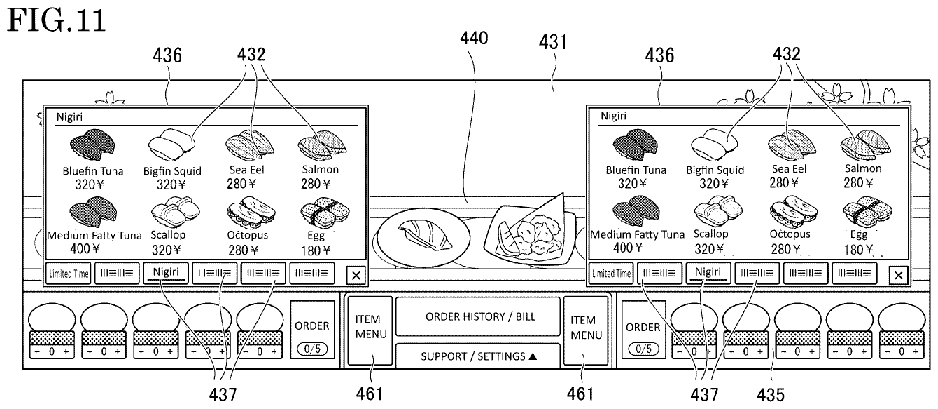

FIG. 11 is a diagram showing a specific example of a menu screen 436. When an item menu button 461 is operated, a menu screen 436 including multiple item images 432 and multiple classification buttons 437 is displayed. When any one of the classification buttons 437 is operated on the menu screen 436, a menu screen 436 containing item images 432 belonging to the classification corresponding to the operated button (in this case, the classification “nigiri”) is displayed. The menu screen 436 may be displayed, for example, superimposed on the item images 432 in the moving display area 440 where the item images 432 are displayed. In this case, while the position of the menu screen 436 remains fixed, each item image 432 in the moving display area 440 may continue to move in a predetermined direction at a predetermined speed. The menu screen 436 displays buttons related to one or more items. Items selected on the menu screen 436 (for example, items whose buttons are operated) are displayed in the order candidate area 435. Thus, the operation to select items for ordering may be implemented in various ways, such as dragging and dropping item images 432 to the order candidate area 435, operating buttons displayed on the menu screen 436, or through other methods.

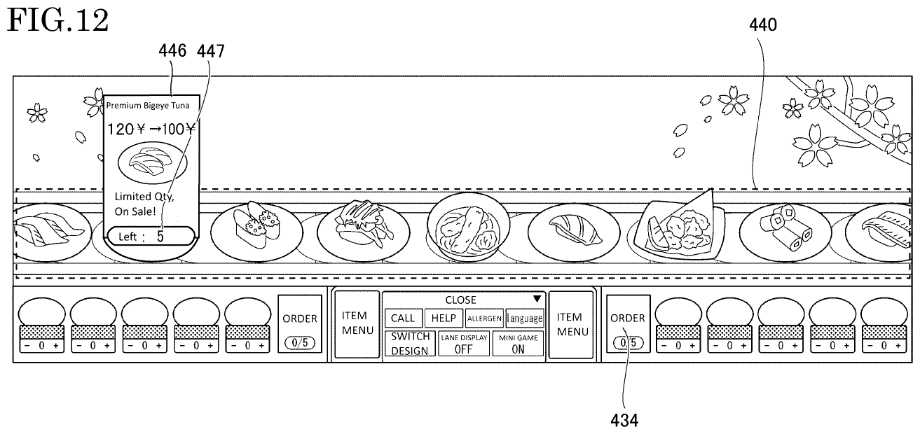

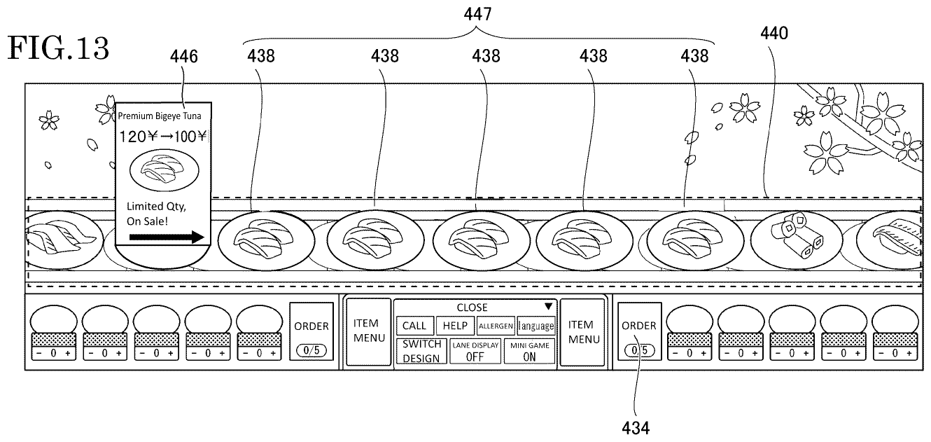

FIGS. 12 and 13 are diagrams illustrating examples where images showing discount information are displayed in a moving display area 440 of an order screen displayed on the establishment display device 43.

Referring to FIGS. 12 and 13, in cases where the items to be ordered are perishable items, establishments have a need to sell all items at a discount before they must be disposed of due to deterioration in freshness. Additionally, customers have a need to purchase items at lower prices. Considering these needs, discount information images may be displayed in the scrolling display area 440 or other areas of the order screen shown on the establishment display device 43. By providing such displays, customer convenience can be improved while reducing the amount of item waste.

Specifically, when necessary, a user (establishment manager) of the establishment control device 30 determines which items among the orderable items should be subject to discount, and inputs into the establishment control device 30 the settings for both the items subject to discount and their remaining quantities. The discounted prices may either be input into the establishment control device 30 by the user of the establishment control device 30, or may be pre-stored in the establishment control device 30. The settings for the determined discount-eligible items and their remaining quantities may alternatively be input into the kitchen display device 40 and transmitted from the kitchen display device 40 to the establishment control device 30.

Upon receiving these settings, the establishment control device 30 creates images announcing the discounted items and images indicating the remaining quantity of the discounted items, and displays them in the moving display area 440 of the order screen on the establishment display device 43. The images announcing the discounted items and the images indicating the remaining quantity of the discounted items are displayed as part of multiple images that are sequentially displayed to move in a predetermined direction along the lane.

In this case, the discounted item is “Premium Bigeye Tuna”, the remaining quantity of the discounted item is “5”, and the discounted price is “100 yen”. In the first example shown in FIG. 12, the image 447 indicating the remaining quantity of the discounted item is included within the image 446 announcing the discounted item. Images 446 and 447 are displayed as a single moving item image. In the second example shown in FIG. 13, the image 446 announcing the discounted item and the discounted item images 438, which are equal in number to the remaining quantity of the discounted item (i.e., “5” pieces), are displayed consecutively. In the second example shown in FIG. 13, the number of discounted item images 438 corresponds to the image 447 indicating the remaining quantity of the discounted item.

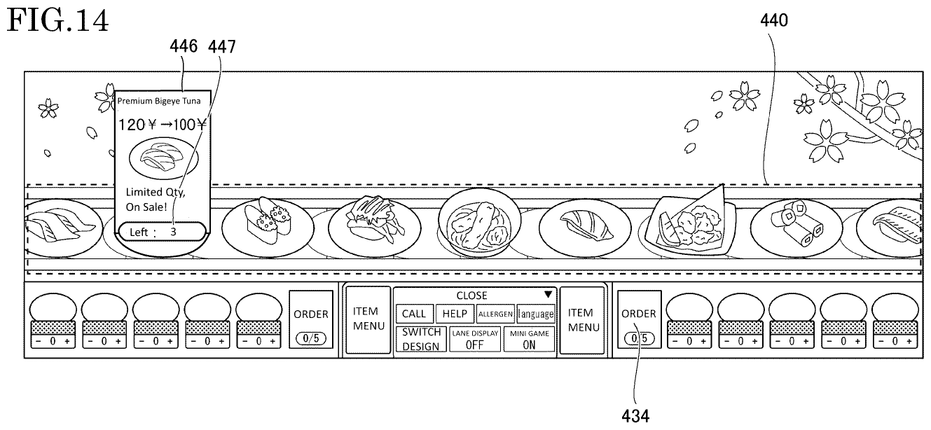

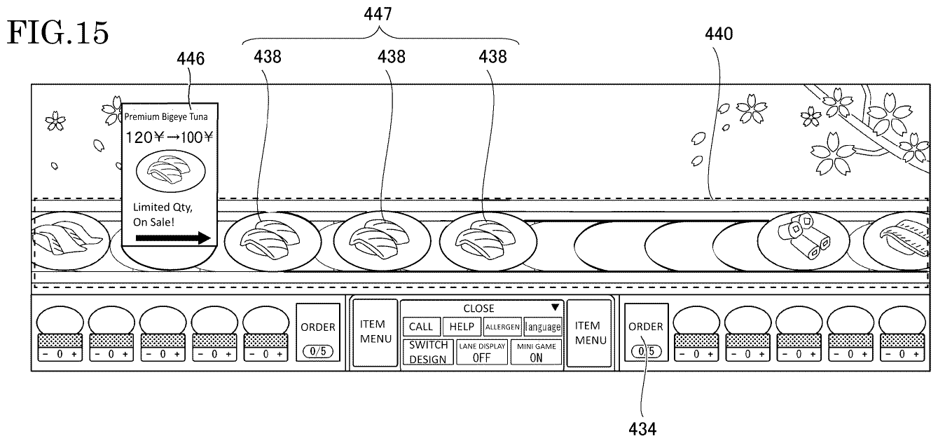

FIGS. 14 and 15 are diagrams showing changes in an image 447 indicating the remaining number of discounted items after an order for the discounted items has been executed.

When a customer wishes to purchase a discounted item, the customer performs a selection operation on either the image 446 announcing the discounted item or the discounted item image 438, followed by operating the order button 434. This executes the order for the discounted item. When the establishment display device 43 accepts the execution of the discounted item order, it transmits the executed order to the establishment control device 30. The establishment control device 30 receives the order for the discounted item made through the establishment display device 43 from the establishment display device 43.

When an order for a discounted item is received, the establishment control device 30 may decrease the remaining quantity shown in image 447 based on the order for the discounted item.

Here, it is assumed that the establishment control device 30 has received orders for two discount-eligible items. In the first example shown in FIG. 12, as illustrated in FIG. 14, the display of the remaining quantity of discount-eligible items shown in image 447 is reduced from ‘5’ to ‘3’. In the second example shown in FIG. 13, as illustrated in FIG. 15, the quantity of discount-eligible item images 438 corresponding to image 447 is reduced from ‘5’ items to ‘3’ items.

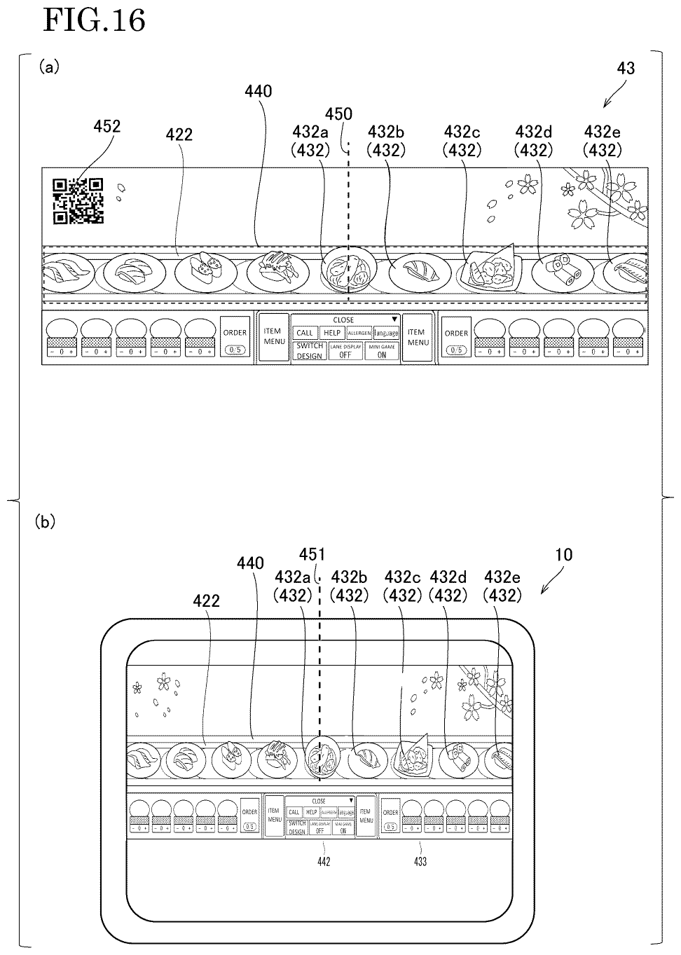

FIG. 16 is a diagram illustrating an example of displaying an order screen on the customer terminal device 10 that is synchronized with the order screen displayed on the establishment display device 43. FIG. 16(a) is a diagram showing the order screen displayed on the establishment display device 43. FIG. 16(b) is a diagram showing the order screen displayed on the customer terminal device 10, which is synchronized with the order screen displayed on the establishment display device 43.

Referring to FIG. 16, when multiple customers are seated at a single unit seat, customers seated far from the establishment display device 43 may find it difficult to operate the establishment display device 43 due to its distance. To eliminate such inconvenience, the establishment control device 30 may display an order screen on the customer terminal device 10 that is synchronized with the order screen displayed on the establishment display device 43.

As shown in FIG. 16(a), in the moving display area 440 of the order screen (an example of a first screen) displayed on the establishment display device 43, an image 422 of the conveyance device 42 and each of the plurality of item images 432 are displayed to move at a predetermined speed in a predetermined direction (in this case, from right to left).

Specifically, an item image 432 present at a predetermined position 450 in the lane (here, at the center position of the lane displayed on the establishment display device 43) is designated as item image 432a, and the item images 432 arranged to the right of item image 432a (that is, the item images 432 arranged upstream in the direction of movement of item images 432) are sequentially designated as item images 432b, 432c, 432d, and 432e. The item images 432 are to pass through the predetermined position 450 in the lane in the order of item images 432a, 432b, 432c, 432d, and 432e.

Furthermore, data storage location information 452 (in this case, a two-dimensional code) is displayed at an arbitrary position on the order screen displayed on the establishment display device 43 (in this case, at the upper left position of the order screen). The data storage location information 452 may include information about the storage location (for example, URL information of the storage location) of data for the customer terminal screen (an example of a second screen) which is the order screen displayed on the customer terminal device 10. The data storage location information 452 may be a code such as a barcode or a two-dimensional code (such as QR code (registered trademark)), or may be information written in text containing the necessary information.

As shown in FIG. 16(b), in the moving display area 440 of the customer terminal screen, an image 422 of the conveyance device 42 and each of the plurality of item images 432 are displayed to move at a predetermined speed in a predetermined direction (in this case, from right to left). The movement of each of the plurality of item images 432 on the customer terminal screen is synchronized with the movement of said plurality of item images 432 on the order screen displayed on the establishment display device 43.

Specifically, item images 432a, 432b, 432c, 432d, and 432e pass through position 451 in the same order as they pass through position 450 in the order screen (FIG. 16(a)) of the establishment display device 43. Position 451 is a predetermined position in the lane on the customer terminal screen (specifically, the central position of the lane displayed on the customer terminal device 10). While it is preferable that item images 432a, 432b, 432c, 432d, and 432e pass through position 451 at the same timing as they pass through position 450, some timing discrepancy may occur due to factors such as slow communication speed between the establishment control device 30 and the customer terminal device 10.

The order screen displayed on the customer terminal and the order screen displayed on the establishment display device 43 need not be identical. For example, the customer terminal screen may be a simplified version of the order screen displayed on the establishment display device 43. The data storage location information 452 may or may not be displayed on the customer terminal screen.

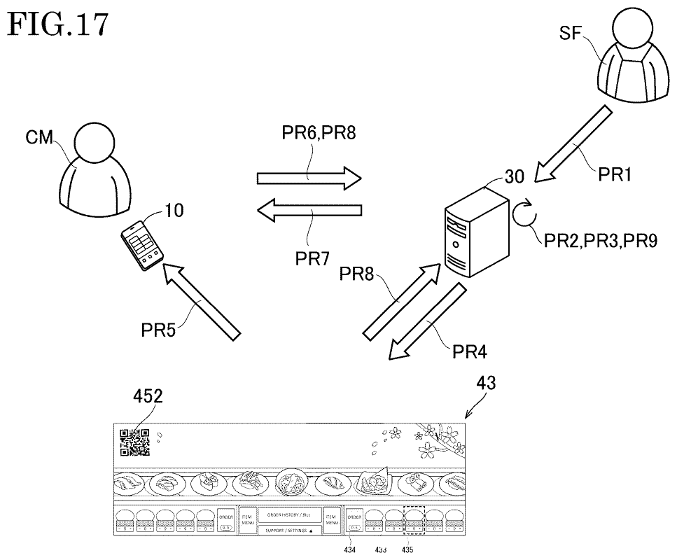

FIG. 17 is a diagram illustrating an example of operations performed when displaying a customer terminal screen on the customer terminal device 10.

Referring to FIG. 17, a user SF (such as an establishment staff member) of the establishment control device 30 assigns visit information to a customer CM when the customer CM visits the establishment. The visit information may be any information assigned to the customer CM, for example, a reservation number indicating the order of seat reservations, or customer information related to the customer CM managed by the establishment or a system cooperating with the establishment. The visit information may also be generated by the establishment control device 30 when the customer CM makes a seat reservation through the customer terminal device 10 to the establishment control device 30.

When guiding a customer CM to a seat, a user (such as an establishment staff member) of the establishment control device 30 inputs seat information, which identifies the seat to be guided to, along with the customer CM's visit information into the establishment control device 30. Through this input, the establishment control device 30 acquires the seat information and visit information (Process PR1). In Process PR1, the establishment control device 30 may acquire the customer CM's customer information (visit information) through communication or file coordination with external servers and the like that can communicate with the establishment control device 30.

When the establishment control device 30 receives input of seat information and visit time information, it generates a customer terminal screen and temporarily stores the data in a predetermined storage location of the establishment control device 30 (Process PR2). The generated customer terminal screen corresponds to a display screen to be displayed on the establishment display device 43 installed at the seat indicated by the seat information.

The establishment control device 30 generates data storage location information 452 (process PR3) including a URL which is a storage location of customer terminal screen data, visit information, and a code (such as a two-dimensional code) containing seat information, and displays it on the establishment display device 43 installed at customer CM's seat (process PR4). From a security perspective, in process PR4, the establishment control device 30 may display the code only for a predetermined period of time. Additionally, in process PR4, the location for displaying the code is not limited to the establishment display device 43 and can be arbitrary. For example, the establishment control device 30 may output a paper with the printed code when guiding the customer CM to their seat, and hand it to the customer CM.

Customer CM reads the data storage location information 452 using a camera of the customer terminal device 10 that they possess. Through this operation, the customer terminal device 10 acquires the URL, which is the storage location of the customer terminal screen data, along with the visit information and seat information (Process PR5). The customer terminal device 10 accesses the storage location of the customer terminal screen data and transmits the visit information and seat information to the establishment control device 30 (Process PR6).

When the visit information and seat information match those input by the user of the establishment control device 30, the establishment control device 30 transmits customer terminal screen data to the customer terminal device 10 (Process PR7). Upon receiving the customer terminal screen data, the customer terminal device 10 displays the customer terminal screen.

The data storage location information 452, may include at least information about the storage location of data for the customer terminal screen. The establishment control device 30 may unconditionally transmit the customer terminal screen data to any terminal that accesses the storage location of the customer terminal screen data. However, by generating data storage location information 452 that includes the storage location of the customer terminal screen data, visit information, and seat information, it becomes possible to determine whether a terminal accessing the storage location of the customer terminal screen data has legitimate authorization. As a result, erroneous orders from individuals unrelated to the customer at that corresponding seat can be prevented.

The establishment control device 30 receives order information made through each of the establishment display device 43 and the customer terminal device 10 from each of the establishment display device 43 and the customer terminal device 10 (Process PR8). The establishment control device 30 manages the order information received from the establishment display device 43 and the order information received from the customer terminal device 10 as orders made at the same said seat (Process PR9).

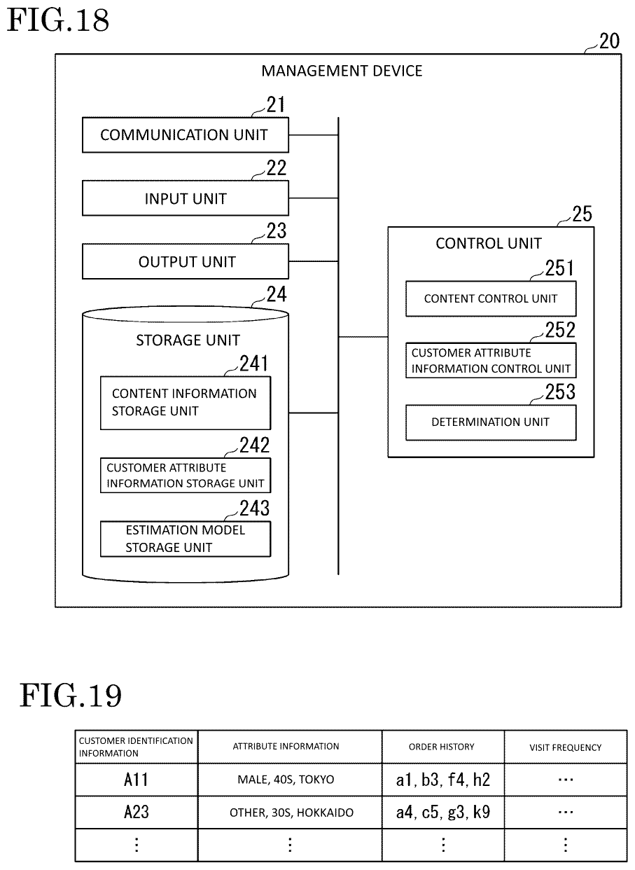

FIG. 18 is a schematic block diagram showing a specific example of the management device 20. The management device 20 is configured using an information device such as a personal computer or a server device. The management device 20 includes a communication unit 21, an input unit 22, an output unit 23, a storage unit 24, and a control unit 25.

The communication unit 21 is a communication device. The communication unit 21 may be configured as a network interface, for example. The communication unit 21 performs data communication with other devices via the network 70 in response to control from the control unit 25. The communication unit 21 may be either a wireless communication device or a wired communication device.

The input unit 22 is configured using existing input devices such as a keyboard, pointing devices (mouse, tablet, etc.), buttons, and touch screen. The input unit 22 is operated by the user (administrator) of the management device 20 when inputting instructions to the management device 20. The input unit 22 may be an interface for connecting input devices to the management device 20. In this case, the input unit 22 inputs input signals generated in response to the administrator's input at the input device to the management device 20. The input unit 22 may be configured using a microphone and voice recognition device. In this case, the input unit 22 acquires acoustic signals generated by the administrator's speech, performs voice recognition of the words spoken by the administrator, and inputs the recognition results as character string information to the management device 20. The voice recognition processing may be executed by the control unit 25. The input unit 22 may be configured in any manner as long as it is capable of inputting the administrator's instructions to the management device 20.

The output unit 23 outputs information in a form recognizable by an administrator. The output unit 23 may be a display device such as a liquid crystal display or an organic EL (Electro Luminescence) display. The output unit 23 may be an interface for connecting a display device to the management apparatus 20. In this case, the output unit 23 generates video signals for displaying image data and outputs the video signals to the display device connected thereto. The output unit 23 may be a device that outputs sound, such as a speaker. The output unit 23 may be an interface for connecting audio output devices such as speakers or headphones to the management apparatus 20. In this case, the output unit 23 generates audio signals for playing audio data and outputs the audio signals to the audio output device connected thereto. Furthermore, the output unit 23 may be configured as a touch panel integrated with the input unit 22.

The storage unit 24 is configured using storage devices such as a magnetic hard disk device or a semiconductor storage device. The storage unit 24 stores data used by the control unit 25. The storage unit 24 stores data necessary for processing by the control unit 25. The storage unit 24 functions as, for example, a content information storage unit 241, a customer attribute information storage unit 242, and an estimation model storage unit 243.

The content information storage unit 241 stores content information. The content information includes characters and images to be displayed on the establishment display device 43 of the establishment system 110. The content information includes, for example, information (item group data) related to items that may be offered at establishments under the management of the management system 100, information related to advertisements, and information related to games provided to customers.

The customer attribute information storage unit 242 stores a customer attribute information table containing information related to attributes of customers (hereinafter referred to as “customer attribute information”) who are registered in the management system 100. FIG. 19 is a diagram showing a specific example of the customer attribute information table. The customer attribute information table includes multiple customer attribute information records. Each customer attribute information record contains values such as customer identification information, attribute information, order history, and visit frequency. One customer attribute information record contains customer information registered by one customer.

The customer identification information is identification information assigned to each customer. The attribute information may include information related to gender and age group. The order history is information indicating the history of past orders made by that customer. The order history may show the history for a predetermined period going back in time, may show the history for a predetermined number of items going back in time, or may be defined in other ways. The establishment visit frequency is information indicating how frequently that customer visits the establishment. For example, predetermined categories (such as daily, several times per week, once per week, once per month, etc.) may be defined in advance, and information indicating which category that customer falls into may be used as the value of the establishment visit frequency.

The estimation model storage unit 243 stores estimation models. An estimation model is a model used to estimate items that a customer is likely to order based on customer attribute information. The estimation model may be configured as a trained model obtained through machine learning using training data. In this case, for example, as a combination of explanatory variables and objective variables in the training data, a combination of actual customer attribute information (e.g., attribute information and order history) and items actually ordered by customers corresponding to that customer attribute information may be used. Additionally, the combination of explanatory variables and objective variables may be defined in various ways. For example, a combination of past order history and classifications of actually ordered items may be used. For example, a combination of elapsed time from a first action (described later) and subsequently actually ordered items or item classifications may be used. For example, a combination of the time required from a customer's first action to second action (described later) and subsequently actually ordered items or item classifications may be used. The estimation model may also be information such as a Look Up Table (LUT) obtained through analytical processing based on past statistics.

The control unit 25 is configured using a processor such as a CPU (Central Processing Unit) and a memory (main storage device). The control unit 25 functions as a content control unit 251, a customer attribute information control unit 252, and a determination unit 253 by executing programs through the processor. All or part of the functions of the control unit 25 may be implemented using hardware such as an ASIC (Application Specific Integrated Circuit), PLD (Programmable Logic Device), or FPGA (Field Programmable Gate Array). The aforementioned program may be recorded on a computer-readable recording medium. The computer-readable recording medium includes portable media such as flexible disks, magneto-optical disks, ROM, CD-ROM, semiconductor storage devices (e.g., SSD: Solid State Drive), and storage devices such as hard disks and semiconductor storage devices built into computer systems. The aforementioned program may also be transmitted via telecommunications lines.

The content control unit 251 accepts registration of content information. For example, the content control unit 251 receives content information received via the communication unit 21 or content information input via the input unit 22. The content control unit 251 records the received content information in the content information storage unit 241. The content control unit 251 may transmit the content information stored in the content information storage unit 241 to all establishment systems 110 at predetermined timing (for example, once a day at a predetermined time). The content information transmitted from the content control unit 251 is, for example, received by the establishment control device 30 of each establishment system 110.

The customer attribute information control unit 252 controls the customer attribute information stored in the customer attribute information storage unit 242. For example, the customer attribute information control unit 252 may receive customer attribute information transmitted as a registration request from the customer terminal device 10, generate a new customer attribute information record using the received customer attribute information, and register it in the customer attribute information table. The customer attribute information control unit 252 may receive information indicating a customer's order history from the establishment control device 30 and update the order history in the customer attribute information.

When receiving a determination request, the determination unit 253 determines items to be preferentially displayed (hereinafter referred to as “priority display items”) for a customer indicated by customer attribute information included in the determination request. The determination unit 253 sends the priority display items, which are the determination results, to the source of the determination request. The source of the determination request (for example, the establishment control device 30) displays item images 432 of items included in the priority display items on the establishment display device 43 of the unit seat 44 where the customer is seated.

The determination unit 253 may estimate items that are likely to be ordered by customers and determine such estimated items as priority display items. Such determination may be performed by any processing. More specifically, the following describes the details.

For example, the determination unit 253 may estimate items likely to be ordered by a customer based on customer attribute information and an estimation model stored in the estimation model storage unit 243. The determination unit 253 may estimate items likely to be ordered based on attribute information of the customer included in the customer attribute information. For example, items may be estimated based on information such as gender, age group (age) included in the attribute information and the estimation model. The determination unit 253 may estimate items likely to be ordered based on the customer's past order history included in the customer attribute information. In this case, the determination unit 253 may estimate items likely to be ordered by the customer based on the estimation model stored in the estimation model storage unit 243 and the order history.

The determination unit 253 may determine priority display items based on predefined relationships between similar items, where items similar to items that the customer has ordered relatively frequently in the past are designated as priority display items. For example, if items related to ‘tuna’ have been frequently ordered in the past, item groups defined as similar to tuna may be determined as priority display items. For instance, items in the same or similar price range as items that have been ordered relatively frequently in the past may be determined as priority display items. If high-priced items have been ordered more frequently than a predetermined threshold in the past, item groups classified as high-priced items may be determined as priority display items. It is desirable that the relationship between price ranges and items be predefined.

For example, the determination unit 253 may determine priority display items based on the elapsed time from a customer's first action. As a specific example of the first action, there is entering the establishment. In this case, the determination unit 253 determines priority display items based on the elapsed time since the customer entered the establishment. Specifically, when the elapsed time since entering the establishment is shorter than a predetermined time (for example, 1 minute, 5 minutes), beverages (for example, soft drinks or alcoholic beverages) may be determined as priority display items. When the elapsed time since entering the establishment is longer than a predetermined time (for example, 30 minutes, 1 hour, or in cases where there is a usage time limit at the establishment, a predetermined time before the usage time limit (for example, 10 minutes before)), items classified as desserts or items classified as tea (including coffee) may be determined as priority display items.

Such determination may be made not based on the elapsed time since entering the establishment, but when certain conditions are met (for example, when no orders have been placed yet). Additionally, the determination may be made based on the elapsed time since the customer sat down, rather than the elapsed time since entering the establishment, or may be made based on the elapsed time since the registration of the seat identification information and customer identification information. In this case, the first action becomes the action of sitting down or the action of registering the seat identification information and customer identification information.

As another specific example of the first operation, there is an ordering operation. In this case, the determination unit 253 determines priority display items based on the elapsed time since the customer's last order. Specifically, when a predetermined length of time or more has elapsed since the customer's last order, the determination unit 253 may determine as priority display items: items categorized as finishing meals (such as rice bowls and ramen), items categorized as desserts, and items categorized as tea (including coffee).

For example, the determination unit 253 may determine priority display items based on the time required from a customer's first action to second action. For example, the first action and the second action may be specifically the second-to-last ordering action and the last ordering action, respectively. In other words, the priority display items may be determined based on the length of time required between orders. When this required time is longer than a predetermined threshold value, items classified as end-of-meal dishes (such as rice bowls and ramen), items classified as desserts, or items classified as tea (including coffee) may be determined as priority display items.

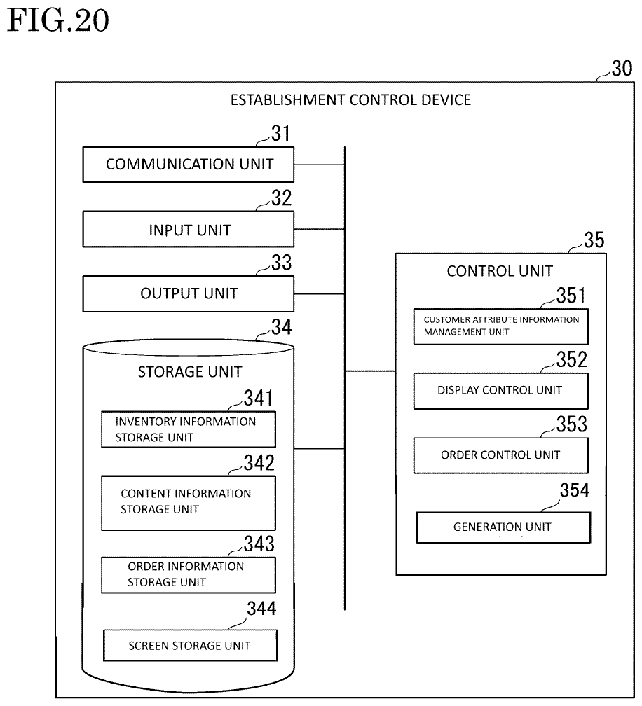

FIG. 20 is a schematic block diagram showing a specific example of the establishment control device 30. The establishment control device 30 is configured using information equipment such as a personal computer or a server device. The establishment control device 30 includes a communication unit 31, an input unit 32 (an example of a designation receiving unit and an establishment visit information acquiring unit), an output unit 33, a storage unit 34, and a control unit 35.

The communication unit 31 is a communication device. The communication unit 31 may be configured as a network interface, for example. The communication unit 31 performs data communication with other devices via network 71 in response to control from the control unit 35. The communication unit 31 may be either a wireless communication device or a wired communication device.

The input unit 32 is configured using existing input devices such as a keyboard, pointing devices (mouse, tablet, etc.), buttons, and touch panel. The input unit 32 is operated by the user (establishment manager) when inputting instructions to the establishment control device 30. The input unit 32 accepts various operations such as setting discounted items among the orderable items and the remaining quantity of these discounted items, as well as establishment visit information. The input unit 32 may be an interface for connecting input devices to the establishment control device 30. In this case, the input unit 32 inputs signals to the establishment control device 30 generated in response to the establishment manager's input at the input device. The input unit 32 may also be configured using a microphone and voice recognition device. In this case, the input unit 32 acquires acoustic signals generated by the establishment manager's speech, performs voice recognition of the words spoken by the establishment manager, and inputs the recognized text information to the establishment control device 30. The voice recognition processing may be executed by the control unit 35. The input unit 32 may be configured in any way as long as it can input the establishment manager's instructions to the establishment control device 30.

The output unit 33 outputs information in a form recognizable by the establishment manager. The output unit 33 may be a display device such as a liquid crystal display or an organic EL display. The output unit 33 may be an interface for connecting a display device to the establishment control device 30. In this case, the output unit 33 generates video signals for displaying image data and outputs the video signals to the display device connected to itself. The output unit 33 may be a device that outputs sound, such as a speaker. The output unit 33 may be an interface for connecting audio output devices such as speakers or headphones to the establishment control device 30. In this case, the output unit 33 generates audio signals for playing audio data and outputs the audio signals to the audio output device connected to itself. The output unit 33 may also be configured as a touch panel integrated with the input unit 32.

The storage unit 34 is configured using storage devices such as a magnetic hard disk device or a semiconductor storage device. The storage unit 34 stores data used by the control unit 35. The storage unit 34 stores data necessary for processing by the control unit 35. The storage unit 34 functions as, for example, an inventory information storage unit 341, a content information storage unit 342, an order information storage unit 343 (an example of order management unit), and a screen storage unit 344 (an example of data storage unit).

The inventory information storage unit 341 stores information related to inventory in the establishment where the apparatus (establishment control device 30) is installed. The inventory-related information may be input, for example, by an establishment administrator operating the input unit 32. The inventory-related information may be updated based on current inventory information, information about newly purchased items, and information about items provided to customers through orders.

The content information storage unit 342 stores content information. The content information stored in the content information storage unit 342 may be content information transmitted from the management device 20. The content information may include information related to items (food and beverages) that are out of stock in the establishment.

The order information storage unit 343 stores (manages) information related to the history of orders placed by customers at the establishment where the device (establishment control device 30) is installed. The order information storage unit 343 includes, for each unit seat 44, customer information (e.g., identification information), order information, information indicating whether items included in the order have been served, and information indicating whether payment has been made.

The screen memory unit 344 stores (saves) data of a customer terminal screen which is an order screen to be displayed on the customer terminal device 10.

The control unit 35 is configured using a processor such as a CPU and a memory (main memory). The control unit 35, through program execution by the processor, functions as a customer attribute information management unit 351, a display control unit 352 (an example of display unit and order screen display unit), an order control unit 353 (an example of order receiving unit, first order receiving unit, and second order receiving unit), and a generation unit 354 (an example of generation unit). All or part of the functions of the control unit 35 may be implemented using hardware such as ASIC, PLD, or FPGA. The aforementioned program may be recorded on a computer-readable recording medium. The computer-readable recording medium includes portable media such as flexible disks, magneto-optical disks, ROM, CD-ROM, semiconductor storage devices (e.g., SSD: Solid State Drive), and storage devices such as hard disks and semiconductor storage devices built into computer systems. The aforementioned program may also be transmitted via telecommunications lines.

The customer attribute information management unit 351 manages information related to customers who visit the establishment where the device (establishment control device 30) is installed. The customer attribute information management unit 351 registers the unit seat 44 and customer attribute information in the order information storage unit 343 in association with each other. The association between the unit seat 44 and customer attribute information may be obtained through any type of processing.

For example, when a customer enters an establishment, a designated reader of the establishment system 110 may read code information displayed on the customer terminal device 10, and when the unit seat 44 to be provided to that customer is registered by an establishment employee, the unit seat 44 may be associated with customer attribute information. The unit seat 44 to be provided to the customer may be selected by the customer attribute information management unit 351 from among available unit seats 44 according to the number of customers. The code information read by the designated reader may include customer identification information. The customer attribute information management unit 351 obtains the customer identification information by decoding the read code information. The customer attribute information management unit 351 registers the seat identification information indicating the unit seat 44 in association with the customer identification information in the order information storage unit 343.

For example, the association between the unit seat 44 and customer attribute information may be performed by capturing code information displayed on the customer terminal device 10 with a predetermined imaging device provided at the unit seat 44. In this case, the imaging device transmits seat identification information indicating the unit seat 44 where the device is installed, along with the captured code information, to the establishment control device 30. The customer attribute information management unit 351 registers the customer identification information indicated by the code information in association with the seat identification information in the order information storage unit 343.

For example, the association between the unit seat 44 and customer attribute information may be performed by having the customer read code information provided for each unit seat 44 using the customer terminal device 10. In this case, the customer terminal device 10 may transmit to the management device 20 the customer identification information stored in its own device along with the establishment identification information and seat identification information obtained by decoding the code information. The management device 20 transmits the customer identification information and seat identification information in association with each other to the establishment control device 30 of the establishment system 110 indicated by the establishment identification information. The customer attribute information management unit 351 registers the received customer identification information and seat identification information in association with each other in the order information storage unit 343.

The display control unit 352 controls the display of the establishment display device 43. When there is no particular operation by a customer, the display control unit 352 selects display target items from the item group data stored in the content information storage unit 342. At this time, the display control unit 352 may select items that are in stock at the establishment where the device is installed as display target items. The display control unit 352 displays the items included in the display target items on the establishment display device 43. For example, the display control unit 352 may randomly select items from among the items included in the display target items and display them on the establishment display device 43 in the order of selection. Furthermore, when the display control unit 352 receives access from a customer terminal device 43 to the storage location of customer terminal screen data, it transmits the customer terminal screen data to that customer terminal device 43.

The display control unit 352 may determine items to be preferentially displayed (priority display items) for each unit seat 44 based on predetermined criteria. For example, the display control unit 352 may send a determination request for each unit seat 44 to the management apparatus 20 and determine the priority display items according to the priority display items received as determination results. In this case, the display control unit 352 may determine the priority display items from among the items that can be provided to customers at the establishment where the apparatus is installed (for example, items in stock) among the priority display items determined by the management apparatus 20. The determination request includes information necessary for determining priority display items in the management apparatus 20. Items determined as priority display items are displayed on the establishment display device 43 at a higher frequency than items not determined as priority display items. Items displayed other than priority display items may be determined according to normal display control. For example, items displayed other than priority display items may be randomly selected from among the items included in the display target items as described above.

The display control unit 352 may control the display such that, among the number of items displayed per unit timing, a predetermined number (hereinafter referred to as “priority display number”) of item images 432 are displayed for items determined as priority display items. The unit timing may be defined as, for example, a unit time (such as 30 seconds, 1 minute, etc.) or as a unit number of items (such as 5 items, 10 items). When the unit timing is defined as 30 seconds and the priority display number is defined as 5, the display is controlled such that 5 priority display items are displayed within a 30-second period.

The order control unit 353 accepts orders according to customer operations. The order control unit 353 receives order information from each of the establishment display device 43 and the customer terminal device 10 for orders placed through these devices. For example, when an order is placed based on customer operations as explained in FIGS. 4-11, 12, 13, and 17, the order control unit 353 may register the ordered items in association with the unit seat 44 where the order was placed in the order information storage unit 343. The order control unit 353 displays the ordered items in association with the unit seat 44 where the order was placed on the kitchen display device 40.

The generation unit 354 generates data storage location information including information on a storage location of data for a customer terminal screen.

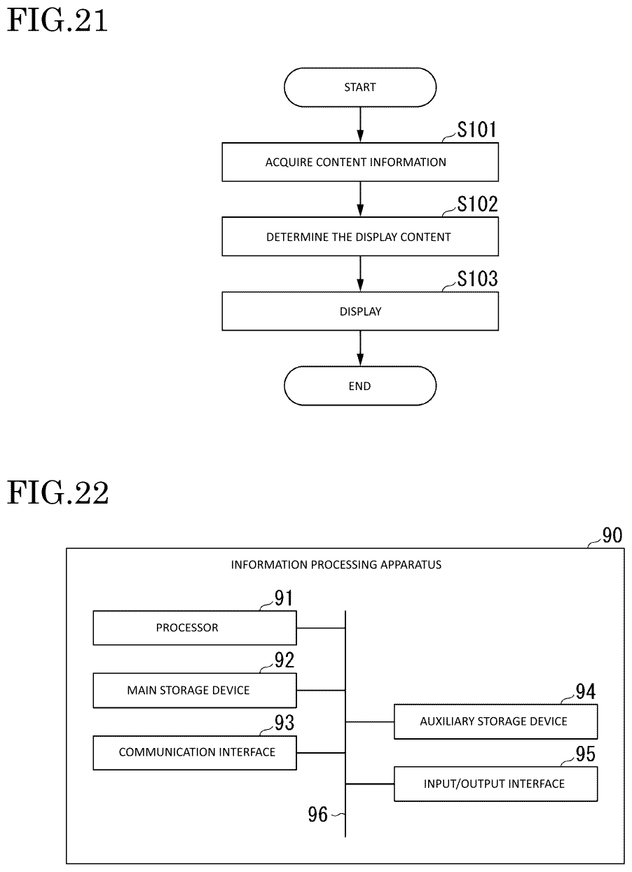

FIG. 21 is a flowchart showing a specific example of the processing performed by the establishment control device 30. First, the display control unit 352 receives and acquires content information from the management device 20 (step S101). The display control unit 352 records the received content information in the content information storage unit 342. The display control unit 352 determines the display content for each establishment display device 43 (step S102) and causes each establishment display device 43 to display images (step S103). By repeatedly executing the processing of steps S102 and S103, item images and other content are displayed on each establishment display device 43.

FIG. 22 is a diagram showing an outline of an example hardware configuration of an information processing apparatus 90 applicable to the present embodiment. The information processing apparatus 90 includes a processor 91, a main storage device 92, a communication interface 93, an auxiliary storage device 94, an input/output interface 95, and an internal bus 96. The processor 91, main storage device 92, communication interface 93, auxiliary storage device 94, and input/output interface 95 are communicably connected to each other via the internal bus 96. The information processing apparatus 90 may be applied to, for example, the management apparatus 20 and the establishment control apparatus 30. In this case, for example, the communication units 21 and 31 may be configured using the communication interface 93. For example, the storage units 24 and 34 may be configured using the auxiliary storage device 94. Furthermore, the control units 25 and 35 may be configured using the processor 91 and the main storage device 92.

### Examples of Variations

The discounted items may include, as shown in FIG. 12 or FIG. 13, items with reduced unit prices (in these figures, items with unit prices reduced from “120 yen” to “100 yen” are shown), as well as items that have increased quantities without changing their unit prices. Even when the item quantity is increased without changing the unit price, the price per unit weight of the item decreases, resulting in an effective discount. Therefore, items with increased quantities are also included in the discounted items.

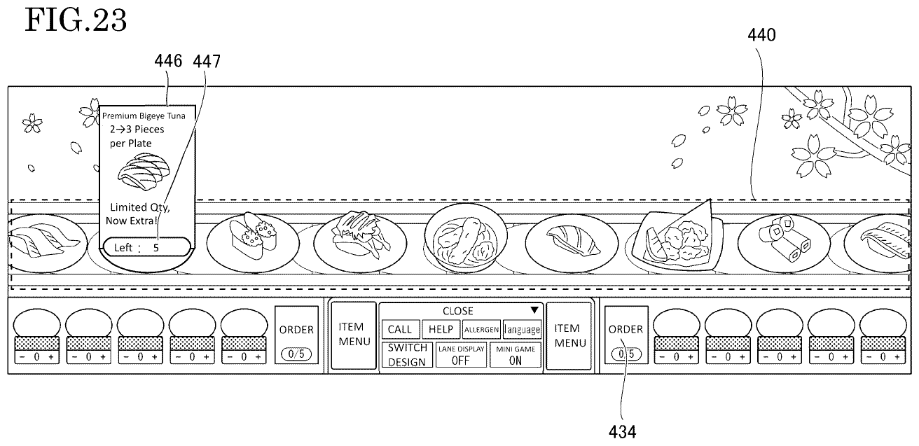

FIG. 23 is a diagram showing a modified example of an image showing discount information displayed in a moving display area 440 of an order screen displayed on the establishment display device 43.

Referring to FIG. 23, in this modified example, the image 446 announcing the discounted item includes a description indicating that the number of sushi pieces containing ‘Premium Bigeye Tuna’ which is the discounted item has been increased from 2 pieces to 3 pieces, along with an image of the item after the quantity increase.

In the present embodiment, while the management device 20 and the establishment control device 30 are configured as separate devices, they may be configured as an integrated device. Additionally, a part of the management device 20 and the establishment control device 30 may be configured as an integrated device. For example, the establishment control device 30 may be configured to include the estimation model storage unit 243 and the determination unit 253. When configured in this manner, the establishment control device 30 can determine priority display items without communicating with (sending determination requests to) the management device 20.

The management device 20 may be implemented using multiple information processing devices. For example, the management device 20 may be implemented using cloud-based devices or similar equipment. For example, in the management device 20, the storage unit 24 and the control unit 25 may each be implemented in different information processing devices. For example, the storage unit 24 of the management device 20 may be implemented in a distributed manner across multiple information processing devices. For example, the control unit 25 of the management device 20 may be implemented in a distributed manner across multiple information processing devices.

While the embodiments of the present invention have been described in detail with reference to the drawings, the specific configuration is not limited to these embodiments, and includes any design modifications and the like within the scope that does not depart from the spirit of the present invention.

### DESCRIPTION OF REFERENCE NUMERALS

10 Customer Terminal Device
20 Control Unit
21, 31 Communication Unit
22, 32 Input Unit (an example of designation receiving unit and establishment visit information acquisition unit)
23, 33 Output Unit
24, 34 Storage Unit
25, 35 Control Unit
30 Establishment Control Device (an example of a control device)
40 Kitchen Display System
41 Conveyance Control Device
42 Conveyance Device
43, 43a, 43b, 43c Establishment Display Device (an example of a display device)
44, 44a, 44b, 44c Unit Seat
70, 71 Network
90 Information processing apparatus
91 Processor
92 Main Storage Device
93 Communication Interface
94 Auxiliary Storage Device
95 Input/Output Interface
96 Internal Bus
100 Management System
110 Establish Management System
241 Content Information Storage Unit
242 Customer Attribute Information Storage Unit
243 Estimation Model Storage Unit
251 Content Control Unit
252 Customer Attribute Information Control Unit
253 Determination Unit
341 Inventory Information Storage Unit
342 Content Information Storage Unit
343 Order Information Storage Unit (Example of Order Management Unit)
344 Customer Terminal Screen Storage Unit (Example of Data Storage Unit)
351 Customer Attribute Information Management Unit
352 Display Control Unit (an example of display unit and order screen display unit)
353 Order Control Unit (an example of order receiving unit, first order receiving unit, and second order receiving unit)
354 Generation Unit (an example of generation unit)
421 Collection Window
422 Image of Conveyance Device
431 Information Display Area
432, 432a, 432b, 432c, 432d, 432e Item Images
433 Order Operation Area
434 Order Button
435 Order Candidate Area
436 Menu Screen
437 Classification Button
438 Discounted Item Image
439 Item Information
440 Moving Display Area (Example of Moving Display Area)
441 Setting Operation Area
442 Support Setting Screen
443 Image Showing Campaign Information
444 Campaign Display Area
445 Campaign Menu Image
446 Image Announcing Discounted Items
447 Image Showing Remaining Quantity of Discounted Items
450, 451 Predetermined Positions in the Lane
452 Data Storage Location Information
461 Item Menu Button

What is claimed is:

1. A control device for controlling a display device provided at a seat, the control device comprising:
a processor and
memory storing instructions that, when executed by the processor, cause the control device to:
display an order screen on the display device, the order screen being used by a customer seated in the seat to order items, wherein the order screen includes a moving display area that sequentially displays each of a plurality of images including images of items to be ordered, moving along a lane in a predetermined direction,
receive a setting of a discount target item among the items to be ordered and the remaining quantity of the discount target item, and
display an image announcing the discount target item and an image indicating the remaining quantity of the discount target item as part of the plurality of images in the moving display area on the order screen, when the setting of the discount target item and the remaining quantity of the discount target item are received.

2. The control device according to claim 1, further the instructions cause the control device to
receive an order for the discount target item through the display device, and
reduce the remaining quantity of the discount target item displayed in the moving display area on the order screen based on the order for the discount target item, when the order for the discount target item is received.

3. The control device according to claim 1, further the instructions cause the control device to
cause the image indicating the remaining quantity of the discounted target items to be included within the image announcing the discounted target items.

4. The control device according to claim 1, further the instructions cause the control device to
display continuously the image announcing the discount target item and images of the discount target item, wherein a number of images of the discount target items is equal to the remaining quantity of the discount target item.

5. A control device for controlling a display device provided at a seat, the control device comprising:
a processor and
memory storing instructions that, when executed by the processor, cause the control device to:
display a first order screen on the display device, used by a customer seated in the seat to order items,
store data of a second order screen used by the customer to order items,
generate data storage location information including information on the storage location of the data of the second order screen, and
transmit the data of the second order screen to a customer terminal device, which is a terminal device possessed by the customer, when access to the storage location of the data of the second order screen is received from the customer terminal device based on the data storage location information,
wherein each of the first and second order screens includes a moving display area that sequentially displays each of a plurality of images, including images of items to be ordered, so that each image moves along a lane in a predetermined direction; and
the movement of each of the plurality of images in the first order screen and the movement of each of the plurality of images in the second order screen are synchronized.

6. The control device according to claim 5, further the instructions cause the control device to
acquire visit information, which is information provided to the customer upon the customer's visit, and
generate a code including the storage location of the data of the second order screen, the visit information, and seat information specifying the seat, as the data storage location information.

7. The control device according to claim 5, further the instructions cause the control device to
receive, from the display device, order information of orders placed through the display device,
receive, from the customer terminal device, order information of orders placed through the customer terminal device along with the visit identification information and seat information, and
manage both the order information received as orders placed at the same seat.
